(19) United States
(12) Patent Application Publication
(10) Pub. No.: US 2025/0315202 A1
(43) Pub. Date: Oct. 9, 2025

(54) MULTIPLE AUDIO TYPE SOUND MACHINE

(71) Applicant: Meriem Menani, Princes Risborough (GB)

(72) Inventor: Meriem Menani, Princes Risborough (GB)

(21) Appl. No.: 18/974,910

(22) Filed: Dec. 10, 2024

(30) Foreign Application Priority Data
Apr. 5, 2024 (GB) 2404857.1
Sep. 27, 2024 (WO) PCT/IB2024/000619

(51) Int. Cl. G06F 3/16

(52) U.S. Cl. CPC G06F 3/165

(57) ABSTRACT

In some implementations, the device may include receiving, from a user, at a physical white noise control, a white noise volume level. In addition, the device may include receiving, from the user, at a physical melody sound control, a melody sound volume level. The device may include receiving, from the user, at a physical nature sound control, a nature sound volume level. Moreover, the device may include outputting, via one or more speakers, a first sound based on the white noise volume level, the melody sound volume level, the nature sound volume level, a default white noise track, a default melody sound track, and a default nature sound track.

### RELATED APPLICATIONS

This application claims the benefit of U.K. Provisional Patent Application Ser. No. 2404857.1 filed on Apr. 5, 2024 and WIPO Application Ser. No. PCT/IB2024/000619 filed on Sep. 27, 2024, the contents of which are incorporated by reference in their entirety.

### TECHNICAL FIELD

The invention generally relates to an audio device, in particular, a device for playing audio to soothe a child.

### BACKGROUND

Many people in many societies struggle to get children to sleep in an increasingly noisy and disturbed world. Often, children may be soothed by familiar sounds, and often, the children may find a repetitive or low-register sound comforting. Not all children are soothed by the same sounds, however, and not all sounds work on every occasion. Therefore, often, children's comforters that play tunes, sounds, or other audio may become less effective over time or may not be particularly well-targeted, even initially.

### SUMMARY

There is a need for a device which may play different types of sounds at varying volume levels, which allows caregivers to better target the combination which is most effective for a particular child in a particular moment.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving, from a user, at a physical white noise control, a white noise volume level. The method may also include receiving, from the user, at a physical melody sound control, a melody sound volume level. The method may furthermore include receiving, from the user, at a physical nature sound control, a nature sound volume level. The method may in addition include outputting, via one or more speakers, a first sound based on the white noise volume level, the melody sound volume level, the nature sound volume level, a default white noise track, a default melody sound track, and a default nature sound track. Other embodiments of this aspect include corresponding computer systems, apparatus, and computer programs recorded on one or more computer storage devices, each configured to perform the actions of the methods.

Implementations may include one or more of the following features. The method may include selecting, by the user, at the physical white noise control, a supplementary white noise track from a plurality of pre-stored white noise tracks. The method may further include selecting, by the user, at the physical melody sound control, a supplementary melody sound track from a plurality of pre-stored melody sound tracks. The method may also include selecting, by the user, at the physical nature sound control, a supplementary nature sound track from a plurality of pre-stored nature sound tracks. The method may further include outputting, via the one or more speakers, a second sound based on the white noise volume level, the melody sound volume level, the nature sound volume level, the supplementary white noise track, the supplementary melody sound track, and the supplementary nature sound track. The method where the plurality of pre-stored white noise tracks, the plurality of pre-stored melody sound tracks, and the plurality of pre-stored nature sound tracks are expanded, contracted, and arranged by a wirelessly connected computing device. The method where a virtual white noise control, a virtual melody sound control, and a virtual nature sound control are accessible via a wirelessly connected computing device. The method where the physical white noise control, the physical melody sound control, and the physical nature sound control are each a knob, where the knob is turned counterclockwise to indicate reducing a respective volume, clockwise to indicate increasing a respective volume, and pressed to indicate changing a respective audio track. The method where the multitrack sound device may further include a timer control which, when activated by the user, allows the user to set a time period after which the multitrack sound device deactivates. The method where the multitrack sound device further may include a light source having a light output when activated and which automatically adjusts based on the first sound. Implementations of the described techniques may include hardware, a method or process, or a computer tangible medium.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a rear perspective view of a multitrack sound device of a nonlimiting embodiment of the invention;

FIG. 2 is a front perspective view of the multitrack sound device of FIG. 1;

FIG. 3 is an exploded rear perspective view of the device of FIG. 1;

FIG. 4 is an exploded front perspective view of the device of FIG. 1;

FIG. 5 is a schematic drawing of an example operating environment of the multitrack sound device;

FIG. 6 is a flowchart showing an example process for operating the multitrack sound device;

FIG. 7 is a rear perspective view of a second example embodiment of the multitrack sound device; and

FIG. 8 is a front perspective view of the second example embodiment of the multitrack sound device.

### DETAILED DESCRIPTION

The systems and methods described herein may comprise a monolithic housing, a transceiver, a loudspeaker, and a plurality of audio output controls, wherein each of the audio output controls may relate to an audio stream, such that a user may be enabled to select more than one such audio stream to play simultaneously through the loudspeaker.

In some embodiments, the systems and methods described herein may comprise a structure attachment for the housing. The structure may be configured to attach to one of a child's cot, bed, bedside table, or any appropriate home furniture. The structure attachment may further comprise any one of a ferromagnetic fastener, a hook and loop fastener, a hook, a vice grip, a screw fastener, and/or one or more resiliently deformable clip mechanisms.

The systems and methods described herein may be configured to be kept close to a user regardless of their location without being dislodged or damaged by the child. In some embodiments, the structure attachment may be permanent, semi-permanent, or temporary.

In some embodiments, the systems and methods described herein may be configured to comprise a transceiver (e.g., BLUETOOTH, near-field communication (NFC), etc.) for local computing device communications. The systems and methods described herein may be configured to provide easy control, updates, or downloads, for example, with a transceiver-enabled computing device (e.g., smartphone or similar easy-to-access and frequently used digital device).

In some embodiments, the systems and methods described herein may be configured to allow for the installation or download of new audio streams to a local memory. In some embodiments, the installation of new audio streams can be downloaded via the internet or recorded via a microphone. The systems and methods described herein may be configured to allow a user to record audio, for example, soothing words from the caregiver, to store as an audio stream or similar effective audio options. In a further example, the systems and methods described herein may be configured to utilize a mother singing a lullaby automatically configured into a loop for continuous playback.

In some embodiments, the systems and methods described herein may be configured to utilize output controls to provide individual adjustments to output levels. The systems and methods described herein may further enable a user to mix the relative levels of the simultaneous audio streams. In some embodiments, the adjustment may be envisaged to allow for an audio track volume to be lower in a mix, and may be controlled remotely via an internet connected computing device or a remote control.

In some embodiments the systems and methods described herein may include use of physical control knobs. The physical control knobs may allow for analogue or incremental adjustments locally, for example in reaction to local conditions of the child.

In some embodiments, the systems and methods described herein may be configured to utilize a timer control. In some embodiments, the timer control may be individually operable via the remote control, or may be operable via local controls.

In some embodiments, the systems and methods described herein may be configured to control each audio stream by a timer, so as to allow an audio stream to become gradually louder, or quieter as a period of time passes. In other embodiments, the timer function may be envisaged that the timer control may be arranged to simply cease or activate audio from the device at a pre-determined time.

In some embodiments, the timer control may comprise a switch. In some embodiments, the switch may be configured to comprise a timer interval arrangement, enabling a user to select cessation/activation after a predetermined period of time (e.g., 30 minutes, 1 hour, 2hours, etc.) or at a future time.

In some embodiments, the systems and methods described herein may be configured to utilize a battery, which may enable the user to place the device anywhere, such as away from an electrical outlet. In some embodiments, the multitrack sound device may be configured to comprise a battery (e.g., a lithium-ion, nickel metal hydride, alkaline, nickel-cadmium, or any appropriate battery technology)

In some embodiments, the systems and methods described herein may be configured to utilize a light projection function which may be synchronized with the one or more sound tracks being played. For example, a light projection may be displayed via a lamp, light emitting diode (LED), liquid crystal display (LCD), digital light processing (DLP), liquid crystal on silicon (LCoS), pico projector, laser, or some combination thereof. In some embodiments, the rhythm or beat of a sound track may be synchronized with the light projection, so the lights may be altered in shape/position/color/based on the sound track.

In some embodiments, the systems and methods described herein may be configured to operate from a plush toy, wherein the components required to operate the systems and methods described herein may be integrated into the interior of the plush toy. For example, the plush toy may have the outward appearance of a cat but with speaker grills and controls accessible to the user.

In some embodiments, the systems and methods described herein may utilize a touch-sensitive screen to allow for a more intuitive interface. For example, the user may engage with the touch-sensitive screen to alter additional audio metrics in addition to volume and to layer a more significant number of tracks simultaneously (i.e., greater than three).

In some embodiments, the systems and methods described herein may be configured to operate from a crib mobile. For example, the crib mobile may comprise a speaker and controls accessible to the user.

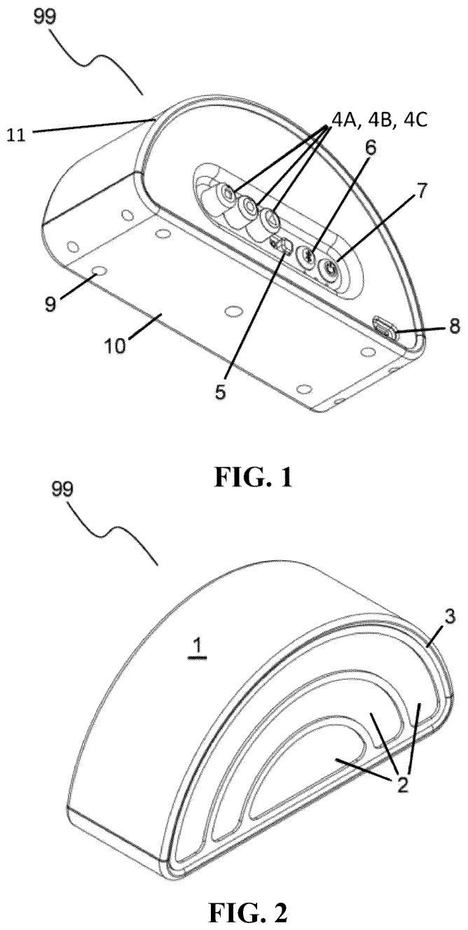

FIGS. 1 and 2 illustrate a rear and front perspective view, respectively, of an example embodiment of a multitrack sound device 99.

With reference to FIG. 1, there is illustrated an example embodiment of the multitrack sound device 99 comprising a plurality of output knobs 4A, 4B, and 4C, wherein each of the controls relates to an audio stream, such that a user is enabled to play more than one such audio stream simultaneously. In some embodiments, each of the plurality of controls may be dedicated to a single type of sound track. For example, output control 4A may be assigned to white noise tracks, output control 4B may be assigned to melody sound tracks, and output control 4C may be assigned to nature sound tracks.

In some embodiments, the multitrack sound device 99 may comprise an automatic shut-off switch 5, a wireless connection button/indicator 6, a power button/indicator 7, and a wired connection port 8. In some embodiments, the automatic shut-off switch 5 may allow a user to select one of a plurality of shut-off times (e.g., 30 minutes, 1 hour, 2 hours, etc.) and activate that timer, where the end of the timer will initiate a shutdown of the multitrack sound device 99 and/or muting of one or more audio tracks.

In some embodiments, the connection button/indicator 6 may allow for synchronizing a wireless connection with the multitrack sound device 99. For example, a BLUETOOTH connection may be initiated by pressing or holding down the connection button/indicator 6. In some embodiments, when the connection has not been established, the connection button/indicator 6 may light up dimly, pulse slowly, or emit a red light and when a connection has been established, the connection button/indicator 6 may light up brightly, pulse quickly, or emit a green light.

In some embodiments, the power button/indicator 7 may be used to cycle the power of the multitrack sound device 99 between on and off. For example, the power button/indicator 7 may indicate that the multitrack sound device 99 is powered off when no light is displayed, may indicate charging when a yellow light is displayed, may indicate powered on when a white light is displayed, and may indicate a shut-off is scheduled when the white light is pulsing.

In some embodiments, the wired connection port 7 may be configured to charge the multitrack sound device 99 and communicatively link the multitrack sound device 99 with an external computing device (not shown). In some embodiments, the wired connection port 7 may be configured to be compatible with mini USB, micro USB, USB type-A, USB type-B, USB type-C, APPLE LIGHTING, FIREWIRE, or any appropriate form of wired communication/charging standard.

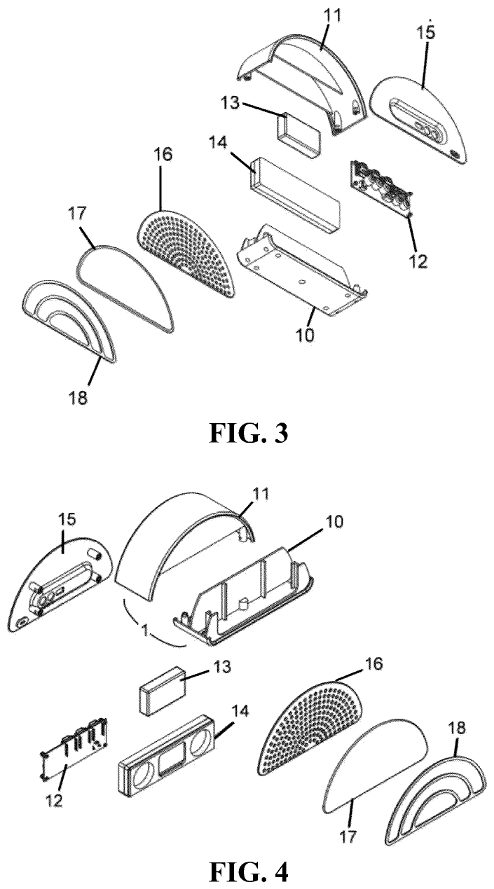

FIGS. 3 and 4 are exploded rear and front perspective views, respectively, of the multitrack sound device 99.

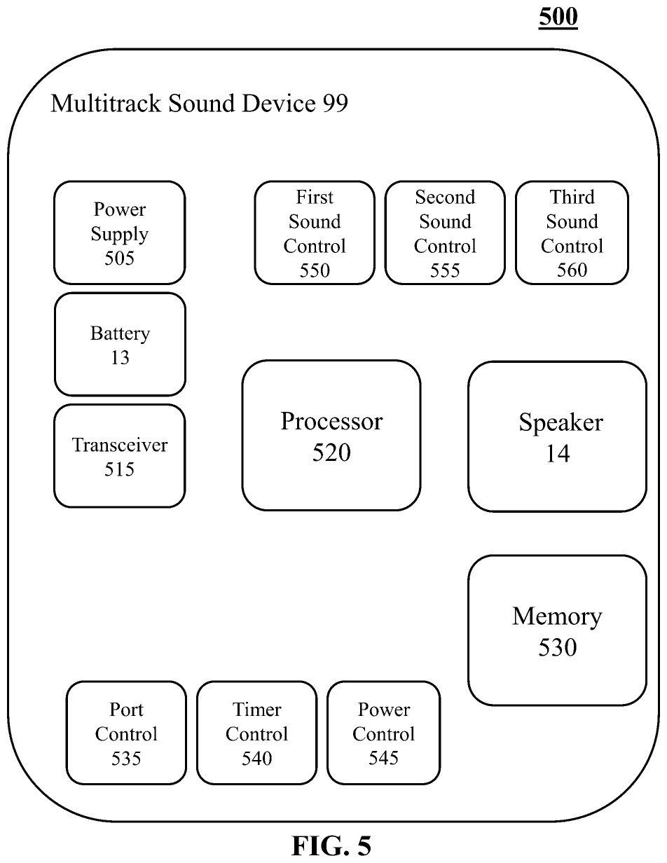

In some embodiments, the multitrack sound device 99 may be configured to comprise a battery 13 (e.g., a lithium-ion, nickel metal hydride, alkaline, nickel-cadmium, or any appropriate battery technology), a speaker 14, and a board 12. In some embodiments, the board 12 may comprise a processor 520 (described below in reference to FIG. 5), the plurality of output knobs 4A, 4B, and 4C, and a memory 530 (described below in reference to FIG. 5). In some embodiments, the output knobs 4A, 4B, and 4C may be potentiometers where a turning of the knob indicates a change in the volume of the related output control.

In some embodiments, the output control knobs may not allow the user to alter the sound track of its respective sound type. In some embodiments, the activation of the device will initiate the playing of the three respective default sound tracks. In some embodiments, tracks switching occurs on the client computing device via an application communicatively linked to the multitrack sound device 99.

In some embodiments, the multitrack sound device 99 may be configured to utilize a central divider section extending upwards from a base 10 to assist in holding the internal components in place.

In some embodiments, the multitrack sound device 99 may comprise a monolithic shell, having a housing 1 with the flat base 10 and an arcuate top edge 11. In some embodiments, the front face 3 may have at least one arcuate slot 2 cut into a cover 18 over a mesh 17 and a perforated loudspeaker protector 16. In some embodiments, the front face 3 and rear face 15 may be flat and orthogonal to the base.

FIG. 5 is a schematic drawing of an example operating environment of the multitrack sound device 99.

In some embodiments, the multitrack sound device 99 may comprise a transceiver 515, which may be configured to transmit or receive audio streams wirelessly. It may be envisaged that the transceiver may enable wireless communications with internet-connected computing devices, such as a smartphone or similar digital device equipped with a microphone. In some embodiments, the transceiver 515 may be configured to exchange information via multiple different standards (e.g., BLUETOOTH, WIFI, cellular signals, near field communication (NFC), infrared (IR) signal, and any other appropriate standard for wireless communication).

In some embodiments, the transceiver 515 may receive commands from a user via a remote control (not shown), which may control audio outputs. For example, the remote control may be a wirelessly enabled device such as a smartphone or personal computer that may adjust equalizer settings related to the audio output.

In some embodiments, the multitrack sound device 99 may comprise a power supply 505, the processor 520, a memory 530, a port control 535, a timer control 540, and a power control 545. In some embodiments, the power supply 505 may be configured to manage the power of the multitrack sound device 99 by controlling the supply of power from an external source and the battery 13. For example, the processor 520 may indicate to the power supply 505 that the power from the battery 13 must be converted to a specific level/frequency and direct where that power must be sent. In some embodiments, the power supply 505 may comprise a transformer for controlling voltage, a rectifier for converting alternating current (AC) power to direct current (DC) power, a filter for providing smooth power, and a regulator for ensuring the power is steady.

In some embodiments, the memory 530 may be communicatively coupled to the processor 520. In some embodiments, the memory 530 may be a non-transitory computer-readable medium capable of storing instructions in a computer-readable format. In some embodiments, the processor may have one or more computing cores which may execute said instructions. For example, the memory 530 may have stored thereon a plurality of sound tracks which may be accessed and converted into a format playable by the speaker 14 by the processor 520.

In some embodiments, the port control 535 may be configured to facilitate communication via a wired connection (i.e., mini USB, micro USB, USB type-A, USB type-B, USB type-C, APPLE LIGHTING, FIREWIRE, or any appropriate form of wired communication standard). For example, the port control 535 may facilitate communication between the multitrack sound device 99 and an external computing device (not shown), allowing the user to transmit new sound tracks and store said sound tracks at the memory 530.

In some embodiments, the timer control 540 may be configured to interact with the automatic shut-off switch 5 to execute the automatic deactivation of the multitrack sound device 99 after a predetermined time. For example, the user may interact with the automatic shut-off switch 5 and indicate a 1-hour time period, then the timer control 540 may track that time and initiate a shut-off when the time elapses.

In some embodiments, the multitrack sound device 99 may further comprise a first sound control 550, a second sound control 555, and a third sound control 560. In some embodiments, the sound controls may be communicatively coupled to a potentiometer and a depressible knob where the sound control may detect a voltage from its respective potentiometer and determine the position of the knob based on the voltage reading. In some embodiments, the position of the knob may determine the desired volume level of the sound track associated with its respective knob. In some embodiments, the depressible knob may be depressed by a user, and that depression may be detected by the respective sound control. In some embodiments, the depressing of the depressible knob indicates a change of the sound track associated with the respective depressible knob.

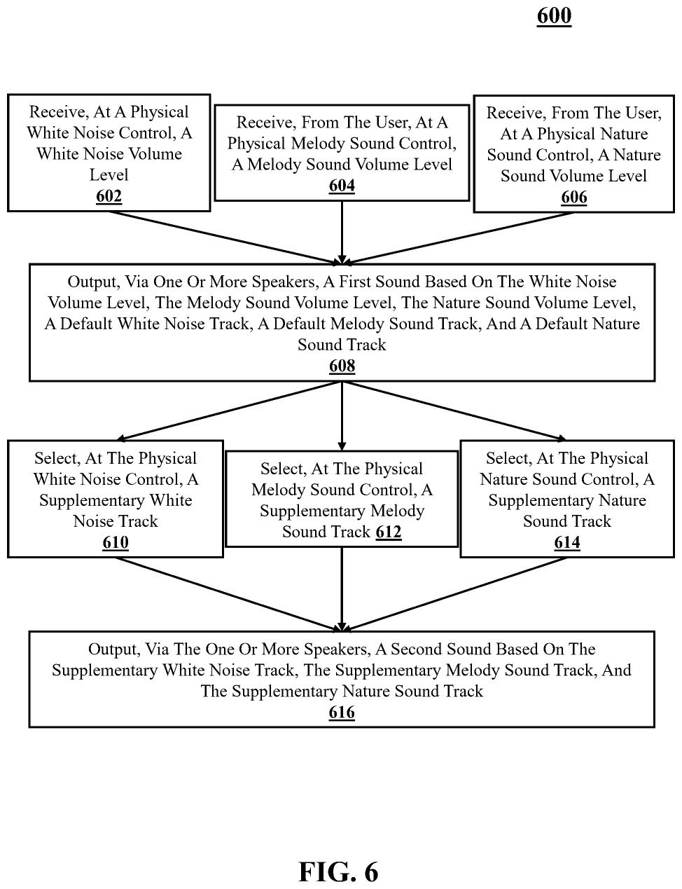

FIG. 6 is a flowchart showing an example process 600 for operating the multitrack sound device 99. Any block of process 600 may be executed by the processor 520. The blocks of process 1800 may be performed in sequence, out of sequence, in parallel, with one or more extra blocks, and with one or more blocks missing.

As shown in FIG. 6, process 600 may include receiving, from a user, at a physical white noise control a white noise volume level (block 602). For example, the user may activate the multitrack music device, and the volume levels may be preset to zero; the user may increase the white noise volume level via the output knob 4A to a 50 percent position, which is detected by the first sound control 550 and reported to the processor 520, as described above. In some embodiments, the white noise track is one of a plurality of white noise tracks, wherein a first white noise track is a default white noise track, and the additional white noise tracks are supplementary white noise tracks. In some embodiments, a white noise track may comprise, but is not limited to, steady shushing, intermittent shushing, static, vacuum, whirring fan, humming, hissing, and any other form of noise where energy is equally distributed across audible frequencies.

As also shown in FIG. 6, process 600 may include receiving, from the user, at a physical melody sound control, a melody sound volume level (block 604). For example, the user may desire a melody played alongside the white noise already playing and move the output knob 4B from a zero-volume position to a 50 percent volume position indicating a desire for the sound emanating from the multitrack sound device 99 to be equal parts white noise and melody sound, as described above. In some embodiments, the melody sound track which plays is one of a plurality of melody sound tracks wherein the first melody sound track is a default melody sound track, and the additional melody sound tracks are supplementary melody sound tracks.

As further shown in FIG. 6, process 600 may include receiving, from the user, at a physical nature sound control, a nature sound volume level (block 606). For example, when the user indicates increasing the volume of control knob 4C to a 50 percent volume position, the processor 520 may be directed to simultaneously play, in addition to the white noise and the melody sound track, the nature sound track at an equivalent volume, as described above. In some embodiments, the nature sound track which plays is one of a plurality of nature sound tracks wherein the first nature sound track is a default nature sound track, and the additional nature sound tracks are supplementary nature sound tracks. In some embodiments, a nature sound track may comprise, but is not limited to, waterfalls, rivers, creeks, babbling brooks, thunder rumbling, and any other nature sound where there is greater energy at lower frequencies than white noise.

As also shown in FIG. 6, process 600 may include outputting, via one or more speakers, a first sound based on the white noise volume level, the melody sound volume level, the nature sound volume level, a default white noise track, a default melody sound track, and a default nature sound track (block 608). For example, the processor 520 may detect from first sound control 550, the second sound control 555, and the third sound control 560 that the user has set each of the audio control knobs to a 50 percent volume level, as described above. In some embodiments, the processor 520 may direct the speaker 14 to play the default white noise track, the default melody sound track, and the default nature sound track at 50 percent of the usable auditory output of the speaker 14.

As further shown in FIG. 6, process 600 may include selecting, by the user, at the physical white noise control, a supplementary white noise track from a plurality of pre-stored white noise tracks (block 610). For example, the user may desire a different white noise track than the default white noise track. In some embodiments, the first sound control 550 may detect the user depressing the associated white noise control knob 4A indicating a desire to cycle to the next available supplementary white noise track. In some embodiments, the processor 520 may select a supplementary white noise track from the memory 530.

As also shown in FIG. 6, process 600 may include selecting, by the user, at the physical melody sound control, a supplementary melody sound track from a plurality of pre-stored melody sound tracks (block 612). For example, the user may desire a different melody sound track than the default melody sound track. In some embodiments, the second sound control 555 may detect the user depressing the associated melody sound control knob 4B indicating a desire to cycle to the next available supplementary melody sound track. In some embodiments, the processor 520 may select a supplementary melody sound track from the memory 530.

As further shown in FIG. 6, process 600 may include selecting, by the user, at the physical nature sound control, a supplementary nature sound track from a plurality of pre-stored nature sound tracks (block 614). For example, the user may desire a different nature sound track than the default nature sound track. In some embodiments, the third sound control 560 may detect the user depressing the associated nature sound control knob 4C indicating a desire to cycle to the next available supplementary nature sound track. In some embodiments, the processor 520 may select a supplementary nature sound track from the memory 530.

As also shown in FIG. 6, process 600 may include outputting, via the one or more speakers, a second sound based on the white noise volume level, the melody sound volume level, the nature sound volume level, the supplementary white noise track, the supplementary melody sound track, and the supplementary nature sound track (block 616). For example, the processor 520 may detect the increased volume indications from the first sound control 550, the second sound control 555, and the third sound control 560. In some embodiments, the processor 520 may increase the audible output of the second sound via speaker 14.

Process 600 may include additional implementations, such as any single implementation or any combination of implementations described below and/or in connection with one or more other processes described elsewhere herein.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

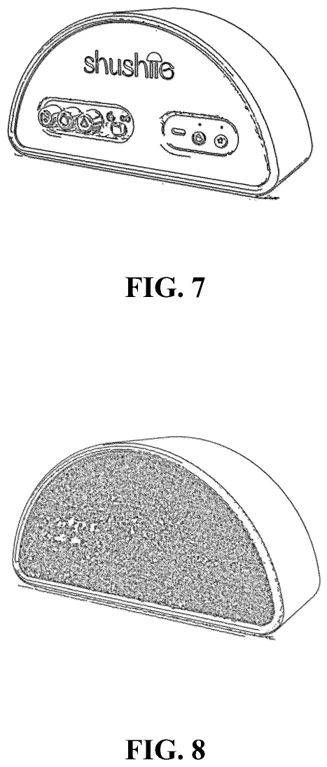

FIGS. 7 and 8 illustrate a rear and front perspective view, respectively, of a second example embodiment of the multitrack sound device.

The second example embodiment comprises differences from the example embodiment of a multitrack sound device described in FIGS. 1 and 2. Those differences comprise movement of the wired connection port on the back and the addition of a uniform front surface.

### Clauses:

Example Clause A: A method for operating a multitrack sound device, may include: receiving, from a user, at a physical white noise control, a white noise volume level; receiving, from the user, at a physical melody sound control, a melody sound volume level; receiving, from the user, at a physical nature sound control, a nature sound volume level; and outputting, via one or more speakers, a first sound based on the white noise volume level, the melody sound volume level, the nature sound volume level, a default white noise track, a default melody sound track, and a default nature sound track.

Example Clause B: The method of Example Clause A, further may include: selecting, by the user, at the physical white noise control, a supplementary white noise track from a plurality of pre-stored white noise tracks; selecting, by the user, at the physical melody sound control, a supplementary melody sound track from a plurality of pre-stored melody sound tracks; selecting, by the user, at the physical nature sound control, a supplementary nature sound track from a plurality of pre-stored nature sound tracks; and outputting, via the one or more speakers, a second sound based on the white noise volume level, the melody sound volume level, the nature sound volume level, the supplementary white noise track, the supplementary melody sound track, and the supplementary nature sound track.

Example Clause C: The method of Example Clause A or Example Clause B, where the plurality of pre-stored white noise tracks, the plurality of pre-stored melody sound tracks, and the plurality of pre-stored nature sound tracks are expanded, contracted, and arranged by a wirelessly connected computing device.

Example Clause D: The method of any one of Example Clauses A-C, where a virtual white noise control, a virtual melody sound control, and a virtual nature sound control are accessible via a wirelessly connected computing device.

Example Clause E: The method of any one of Example Clauses A-D, where the physical white noise control, the physical melody sound control, and the physical nature sound control are each a knob, where the knob is turned counterclockwise to indicate reducing a respective volume, clockwise to indicate increasing a respective volume, and pressed to indicate changing a respective audio track.

Example Clause F: The method of any one of Example Clauses A-E, where the multitrack sound device further may include a timer control which, when activated by the user, allows the user to set a time period after which the multitrack sound device deactivates.

Example Clause G: The method of any one of Example Clauses A-F, where the multitrack sound device further may include a light source having a light output when activated and which automatically adjusts based on the first sound.

Example Clause H: A non-transitory computer-readable medium storing a set of instructions for operating a multitrack sound device, the set of instructions may include: one or more instructions that, when executed by one or more processors of a device, cause the device to: receive, from a user, at a physical white noise control, a white noise volume level; receive, from the user, at a physical melody sound control, a melody sound volume level; receive, from the user, at a physical nature sound control, a nature sound volume level; and output, via one or more speakers, a first sound based on the white noise volume level, the melody sound volume level, the nature sound volume level, a default white noise track, a default melody sound track, and a default nature sound track.

Example Clause I: The non-transitory computer-readable medium of Example Clause H, where the one or more instructions further cause the device to: select, by the user, at the physical white noise control, a supplementary white noise track from a plurality of pre-stored white noise tracks; select, by the user, at the physical melody sound control, a supplementary melody sound track from a plurality of pre-stored melody sound tracks; select, by the user, at the physical nature sound control, a supplementary nature sound track from a plurality of pre-stored nature sound tracks; and output, via the one or more speakers, a second sound based on the white noise volume level, the melody sound volume level, the nature sound volume level, the supplementary white noise track, the supplementary melody sound track, and the supplementary nature sound track.

Example Clause J: The non-transitory computer-readable medium of Example Clause H or Example Clause I, where the plurality of pre-stored white noise tracks, the plurality of pre-stored melody sound tracks, and the plurality of pre-stored nature sound tracks are expanded, contracted, and arranged by a wirelessly connected computing device.

Example Clause K: The non-transitory computer-readable medium of any one of Example Clauses H-J, where a virtual white noise control, a virtual melody sound control, and a virtual nature sound control are accessible via a wirelessly connected computing device.

Example Clause L: The non-transitory computer-readable medium of any one of Example Clauses H-K, where the physical white noise control, the physical melody sound control, and the physical nature sound control are each a knob, where the knob is turned counterclockwise to indicate lowering a respective volume, clockwise to indicate increase a respective volume, and pressed to indicate changing a respective audio track.

Example Clause M: The non-transitory computer-readable medium of any one of Example Clauses H-L, where the multitrack sound device further may include a timer control which, when activated, allows the user to set a time period after which the multitrack sound device deactivates.

Example Clause N: The non-transitory computer-readable medium of any one of Example Clauses H-M, where the multitrack sound device further may include a light source having a light output when activated and which automatically adjusts based on the first sound.

Example Clause O: A system for operating a multitrack sound device may include: one or more processors configured to: receive, from a user, at a physical white noise control, a white noise volume level; receive, from the user, at a physical melody sound control, a melody sound volume level; receive, from the user, at a physical nature sound control, a nature sound volume level; and output, via one or more speakers, a first sound based on the white noise volume level, the melody sound volume level, the nature sound volume level, a default white noise track, a default melody sound track, and a default nature sound track.

Example Clause P: The system of Example Clause O, where the one or more processors are further configured to: select, by the user, at the physical white noise control, a supplementary white noise track from a plurality of pre-stored white noise tracks; select, by the user, at the physical melody sound control, a supplementary melody sound track from a plurality of pre-stored melody sound tracks; select, by the user, at the physical nature sound control, a supplementary nature sound track from a plurality of pre-stored nature sound tracks; and output, via the one or more speakers, a second sound based on the white noise volume level, the melody sound volume level, the nature sound volume level, the supplementary white noise track, the supplementary melody sound track, and the supplementary nature sound track.

Example Clause Q: The system of Example Clause O or Example Clause P, where the plurality of pre-stored white noise tracks, the plurality of pre-stored melody sound tracks, and the plurality of pre-stored nature sound tracks are expanded, contracted, and arranged by a wirelessly connected computing device.

Example Clause R: The system of any one of Example Clauses O-Q, where a virtual white noise control, a virtual melody sound control, and a virtual nature sound control are accessible via a wirelessly connected computing device.

Example Clause S: The system of any one of Example Clauses O-R, where the physical white noise control, the physical melody sound control, and the physical nature sound control are each a knob, where the knob is turned counterclockwise to indicate lowering a respective volume, clockwise to indicate increasing a respective volume, and pressed to indicate changing a respective audio track.

Example Clause T: The system of any one of Example Clauses O-S, where the multitrack sound device further may include a timer control which, when activated, allows the user to set a time period after which the multitrack sound device deactivates.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A method for operating a multitrack sound device, comprising:
receiving, from a user, at a physical white noise control, a white noise volume level;
receiving, from the user, at a physical melody sound control, a melody sound volume level;
receiving, from the user, at a physical nature sound control, a nature sound volume level; and
outputting, via one or more speakers, a first sound based on the white noise volume level, the melody sound volume level, the nature sound volume level, a default white noise track, a default melody sound track, and a default nature sound track.

2. The method of claim 1, further comprising:
selecting, by the user, at the physical white noise control, a supplementary white noise track from a plurality of pre-stored white noise tracks;
selecting, by the user, at the physical melody sound control, a supplementary melody sound track from a plurality of pre-stored melody sound tracks;
selecting, by the user, at the physical nature sound control, a supplementary nature sound track from a plurality of pre-stored nature sound tracks; and
outputting, via the one or more speakers, a second sound based on the white noise volume level, the melody sound volume level, the nature sound volume level, the supplementary white noise track, the supplementary melody sound track, and the supplementary nature sound track.

3. The method of claim 1, wherein a virtual white noise control, a virtual melody sound control, and a virtual nature sound control are accessible via a wirelessly connected computing device.

4. The method of claim 2, wherein the plurality of pre-stored white noise tracks, the plurality of pre-stored melody sound tracks, and the plurality of pre-stored nature sound tracks are expanded, contracted, and arranged by a wirelessly connected computing device.

5. The method of claim 1, wherein the physical white noise control, the physical melody sound control, and the physical nature sound control are each a knob, where the knob is turned counterclockwise to indicate reducing a respective volume, clockwise to indicate increasing a respective volume, and pressed to indicate changing a respective audio track.

6. The method of claim 1, wherein the multitrack sound device further comprises a timer control which, when activated by the user, allows the user to set a time period after which the multitrack sound device deactivates.

7. The method of claim 1, wherein the multitrack sound device further comprises a light source having a light output when activated and which automatically adjusts based on the first sound.

8. A non-transitory computer-readable medium storing a set of instructions for operating a multitrack sound device, the set of instructions comprising:
one or more instructions that, when executed by one or more processors of a device, cause the device to:
receive, from a user, at a physical white noise control, a white noise volume level;
receive, from the user, at a physical melody sound control, a melody sound volume level;
receive, from the user, at a physical nature sound control, a nature sound volume level; and
output, via one or more speakers, a first sound based on the white noise volume level, the melody sound volume level, the nature sound volume level, a default white noise track, a default melody sound track, and a default nature sound track.

9. The non-transitory computer-readable medium of claim 8, wherein the one or more instructions further cause the device to:
select, by the user, at the physical white noise control, a supplementary white noise track from a plurality of pre-stored white noise tracks;
select, by the user, at the physical melody sound control, a supplementary melody sound track from a plurality of pre-stored melody sound tracks;
select, by the user, at the physical nature sound control, a supplementary nature sound track from a plurality of pre-stored nature sound tracks; and
output, via the one or more speakers, a second sound based on the white noise volume level, the melody sound volume level, the nature sound volume level, the supplementary white noise track, the supplementary melody sound track, and the supplementary nature sound track.

10. The non-transitory computer-readable medium of claim 9, wherein the plurality of pre-stored white noise tracks, the plurality of pre-stored melody sound tracks, and the plurality of pre-stored nature sound tracks are expanded, contracted, and arranged by a wirelessly connected computing device.

11. The non-transitory computer-readable medium of claim 8, wherein a virtual white noise control, a virtual melody sound control, and a virtual nature sound control are accessible via a wirelessly connected computing device.

12. The non-transitory computer-readable medium of claim 8, wherein the physical white noise control, the physical melody sound control, and the physical nature sound control are each a knob, where the knob is turned counterclockwise to indicate lowering a respective volume, clockwise to indicate increase a respective volume, and pressed to indicate changing a respective audio track.

13. The non-transitory computer-readable medium of claim 8, wherein the multitrack sound device further comprises a timer control which, when activated, allows the user to set a time period after which the multitrack sound device deactivates.

14. The non-transitory computer-readable medium of claim 8, wherein the multitrack sound device further comprises a light source having a light output when activated and which automatically adjusts based on the first sound.

15. A system for operating a multitrack sound device comprising:
one or more processors configured to:
receive, from a user, at a physical white noise control, a white noise volume level;
receive, from the user, at a physical melody sound control, a melody sound volume level;
receive, from the user, at a physical nature sound control, a nature sound volume level; and
output, via one or more speakers, a first sound based on the white noise volume level, the melody sound volume level, the nature sound volume level, a default white noise track, a default melody sound track, and a default nature sound track.

16. The system of claim 15, wherein the one or more processors are further configured to:
select, by the user, at the physical white noise control, a supplementary white noise track from a plurality of pre-stored white noise tracks;
select, by the user, at the physical melody sound control, a supplementary melody sound track from a plurality of pre-stored melody sound tracks;
select, by the user, at the physical nature sound control, a supplementary nature sound track from a plurality of pre-stored nature sound tracks; and output, via the one or more speakers, a second sound based on the white noise volume level, the melody sound volume level, the nature sound volume level, the supplementary white noise track, the supplementary melody sound track, and the supplementary nature sound track.

17. The system of claim 16, wherein the plurality of pre-stored white noise tracks, the plurality of pre-stored melody sound tracks, and the plurality of pre-stored nature sound tracks are expanded, contracted, and arranged by a wirelessly connected computing device.

18. The system of claim 15, wherein a virtual white noise control, a virtual melody sound control, and a virtual nature sound control are accessible via a wirelessly connected computing device.

19. The system of claim 15, wherein the physical white noise control, the physical melody sound control, and the physical nature sound control are each a knob, where the knob is turned counterclockwise to indicate lowering a respective volume, clockwise to indicate increasing a respective volume, and pressed to indicate changing a respective audio track.

20. The system of claim 15, wherein the multitrack sound device further comprises a timer control which, when activated, allows the user to set a time period after which the multitrack sound device deactivates.
